(19) United States
(12) Patent Application Publication
(10) Pub. No.: US 2024/0149417 A1
(43) Pub. Date: May 9, 2024

(54) NAIL HOLDING DEVICE AND METHOD THEREFOR

(71) Applicant: ARIEL L. SHEVAT, HOLBROOK, AZ (US)

(72) Inventor: ARIEL L. SHEVAT, HOLBROOK, AZ (US)

(21) Appl. No.: 17/982,679

(22) Filed: Nov. 8, 2022

(51) Int. Cl. B25C 3/00; B25B 7/02

(52) U.S. Cl. CPC B25C 3/008; B25B 7/02

(57) ABSTRACT

A nail holding device has a first lever and a second lever. The first lever has a first lever holding section. A first lever handle section extends from the first lever holding section. The first lever holding section extends horizontally below the first lever handle section. A plurality of semi-conical openings is formed along a length of an inside edge of the first lever holding section. Each of the semi-conical openings has a different size opening formed in an apex area of each semi-conical opening, wherein the size openings decrease from a proximate end to a distal end of the first lever holding section. The second lever is pivotably coupled to the first lever. The second lever has a second lever holding section having a smooth inside edge. A second lever handle section extends from the second lever holding section. The second lever holding section extends horizontally below the first lever handle section. A pivot joint pivotably couples the first lever to the second lever.

### RELATED APPLICATIONS

This patent application is related to U.S. Provisional Application No. 63/372,004 filed Feb. 3, 2022, entitled “NAIL HOLDER” in the name of Ariel L. Shevat, and which is incorporated herein by reference in its entirety. The present patent application claims the benefit under 35 U.S.C § 119(e).

### TECHNICAL FIELD

The present application in general relates to a hand tool, and more specifically, to a device that may hold and clasp different size nails in an upright position to allow a user to safely hammer the nail into an object.

### BACKGROUND

When hammering a nail into an object, many individuals hold the nail with their hands. Most individuals generally hold a nail near the head of the nail in an upright position with the point of the nail pressed against a surface of the object to be nailed. What happens many times when hammering a nail is that the user will not hold the nail straight. The user may either not hold the nail in a vertical position or may flinch when hammering the nail. This may cause the nail to go into the object at an angle. When the shank of the nail goes into the object at an angle, this may cause the head of the nail not to be flush with the surface of the object.

Another issue with holding the nail with a user's hand is that some individuals may accidentally hit their hand with the hammer. At a minimum this may cause an extreme amount of pain. Worse, one may break and/or damage the hand.

To overcome the above issues, many individuals may hold the nail with a pair of pliers. While pliers may work for some individuals, for others, it is hard to firmly grasp the nail between the jaws of the pliers. If one is unable to firmly grasp the nail, the nail may move positions between the jaws of the flier when striking the nail. Further, even with pliers, the user may not properly align the nail between the jaws of the pliers causing the nail to be held in an angled position when striking the nail with the hammer.

Therefore, it would be desirable to provide a device and method that overcomes the above. The device and method would allow a user to hold any size nail in an upright position when hammering the nail.

### SUMMARY

In accordance with one embodiment, a nail holding device is disclosed. The nail holding device has a first lever and a second lever. The first lever has a first lever holding section. A first lever handle section extends from the first lever holding section. The first lever holding section extends horizontally below the first lever handle section. A plurality of semi-conical openings is formed along a length of an inside edge of the first lever holding section. Each of the semi-conical openings has a different size opening formed in an apex area of each semi-conical opening, wherein the size openings decrease from a proximate end to a distal end of the first lever holding section. The second lever is pivotably coupled to the first lever. The second lever has a, second lever holding section having a smooth inside edge. A second lever handle section extends from the second lever holding section. The second lever holding section extends horizontally below the first lever handle section. A pivot joint pivotably couples the first lever to the second lever.

In accordance with one embodiment, a nail holding device is disclosed. The nail holding device has a first lever and a second lever. The first lever has a first lever holding section. A first lever handle section extends from the first lever holding section. The first lever holding section extends horizontally below the first lever handle section. A plurality of semi-conical openings is formed along a length of an inside edge of the first lever holding section. Each of the semi-conical openings has a different size opening formed in an apex area of each semi-conical opening, wherein the size openings decrease from a proximate end to a distal end of the first lever holding section. The second lever is pivotably coupled to the first lever. The second lever has a second lever holding section having a smooth inside edge. A second lever handle section extends from the second lever holding section. The second lever holding section extends horizontally below the first lever handle section. A pivot joint pivotably couples the first lever to the second lever. A locking mechanism is provided to lock the first lever handle section to the second lever handle section. A spring is provided for forcing the first lever handle section apart from the second lever handle section.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a perspective view of an exemplary nail holding tool with the jaws open according to one aspect of the present application;

FIG. 2 is a perspective view of an exemplary nail holding tool with the jaws closed according to one aspect of the present application;

FIG. 3 is a side view of an exemplary nail holding tool with the jaws closed according to one aspect of the present application; and

FIG. 4 is a magnified perspective view of an exemplary jaw member of the nail holding tool according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary nail holding device are disclosed. The nail holding device may hold different size nails in an upright manner. The nail holding device has a locking mechanism to secure the nail in the holding device in an upright manner. A spring mechanism forces handles of the nail holding device apart when the locking mechanism is released to allow one the nail holding device to receive another nail.

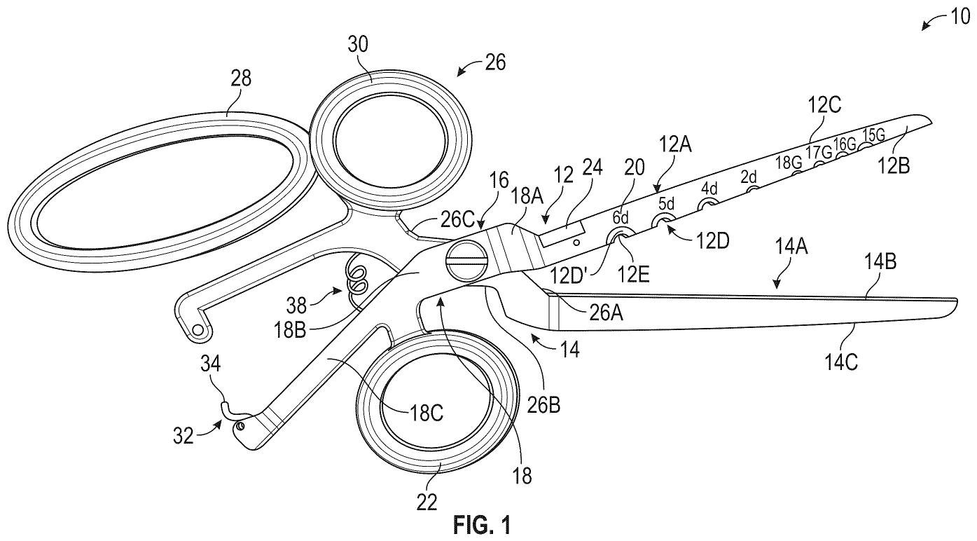

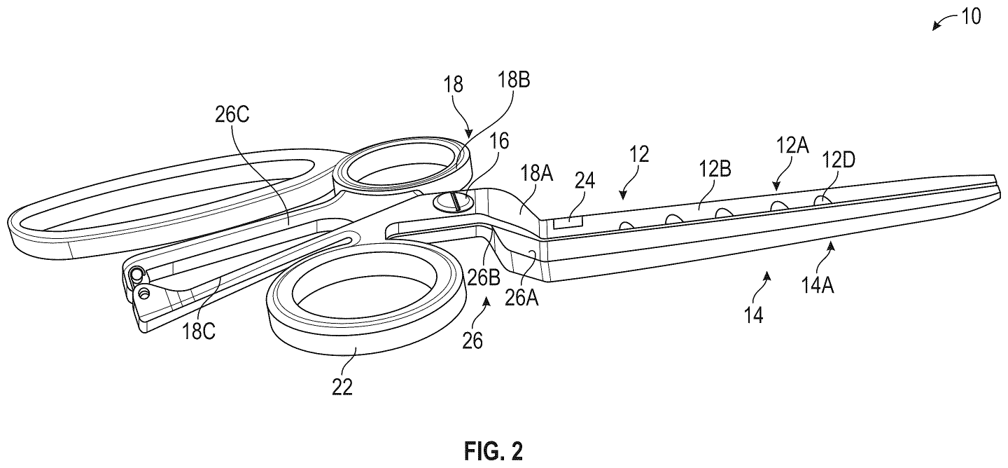

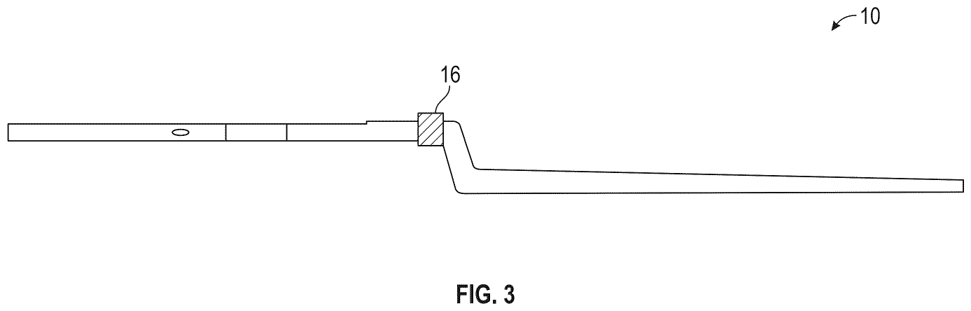

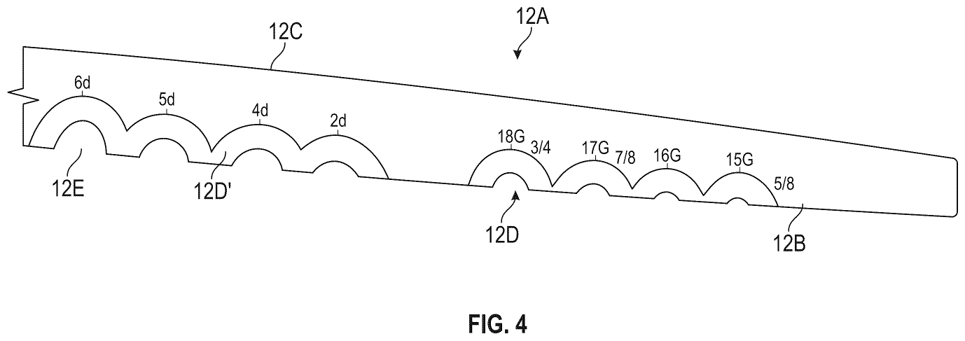

Referring to FIGS. 1-4, a nail holding device 10 (hereinafter device 10) may be seen. The device 10 may have a first lever member 12 pivotably coupled to a second lever member 14 by a pivot joint 16. The first lever member 12 may have a holding section 12A that may have an inner edge 12B and an outer edge 12C. The inner edge 12B may have a plurality of semi-conical openings 12D formed thereon. The plurality of semi-conical openings 12D may be spaced along the length of the inner edge 12B. Each of the semi-conical openings 12D may have a different sized opening 12E formed in an apex area of the semi-conical opening 12D. In accordance with one embodiment, the size of the opening 12E formed in an apex area of the semi-conical opening 12D decreases from a proximate end of the holding section 12A to a distal end of the holding section 12A.

The semi-conical openings 12D may be sized according to different gauge sizes of the nails. Indicia 20 may be formed on the holding section 12A adjacent to each semi-conical opening 12D. The indicia 20 may indicate the size/gauge of each semi-conical openings 12D.

An interior area 12D′ of each semi-conical openings 12D may be polished/sanded/colored or the like. Polishing/sanding/coloring the interior area 12D′ of each semi-conical openings 12D may highlight the semi-conical openings 12D to allow a user to more easily find the desired sized semi-conical opening 12D.

The outer edge 12C may have a magnet 24 formed thereon and/or may be magnetized. The magnet 24 and/or the magnetization of the outer edge 12C may allow a user to pick-up nails using the device 10.

A handle section 18 may extend from one end of the holding section 12A. The handle section 18 may be used to move the holding section 12A as may be described below. The handle section 18 may have first leg member 18A which may extend up and away from a proximate end of the holding section 12A. In accordance with one embodiment, a width of the first leg member 18A may be approximately equal to a width of the proximate end of the holding section 12A. A second leg member 18B may extend horizontally from a distal end of the first leg member 18A. The second leg member 18B may be parallel to the holding section 12A. A third leg member 18C of the handle section 18 may extend away from the second leg member 18B. The third leg member 18C may be planer with the second leg member 18B but angled away from the second leg member 18B. In accordance with one embodiment, the third leg member 18C may extend away from the second leg member 18B at approximately a 135° angle from the second leg member 18B going in a counterclockwise direction. The configuration of the handle section 18 may allow the holding section 12A to be positioned below and parallel to the handle section 18.

A ring member 22 may be coupled to the handle section 18. In accordance with one embodiment, the ring member 22 may be coupled to the handle section 18 approximately in a middle area of the third leg member 18C of the handle section 18. The ring member 22 may form a thumb ring for a user to insert his/her thumb when using the device 10.

The second lever member 14 may have a holding section 14A that may have an inner edge 14B and an outer edge 14C. In this embodiment, both the inner edge 12B and the outer edge 14C may be smooth.

A handle section 26 may extend from the holding section 14A of the second lever member 14. The handle section 26 may be used to move the holding section 14A as may be described below. The handle section 26 may have first leg member 26A. The first leg member 26A may extend up and away from a proximate end of the holding section 14A. In accordance with one embodiment, a width of the first leg member 26A may be approximately equal to a width of the proximate end of the holding section 14A. A second leg member 26B may extend from a distal end of the first leg member 26A. The second leg member 26B may extend from a first leg member 26A. The second leg member 26B may run parallel to the holding section 14A. A first section of the second leg member 26B may run away from the holding section 14A. This may allow the holding section 14A to be offset to a side of the handle section 26. A second section may run horizontally from and in a same plane as the holding section 14A. In accordance with one embodiment, the second leg member 26B is “L” shaped with the bottom leg of the “L” being at approximately 135° running clockwise. A third leg member 26C of the handle section 26 may extend horizontally from the second leg member 26B and away from the second leg member 26B.

An oblong ring member 28 may be coupled to the handle section 26, In accordance with one embodiment, the oblong ring member 28 may be coupled to the third leg member 26C of the handle section 26. As may be seen in the FIGs., the oblong ring member 28 may be coupled to a distal end of the third leg member 26C. The oblong ring member 28 may be configured to be curved such that opposing ends of the oblong ring member 28 may be bent inwards. In this configuration, the oblong ring member 28 may be bean shaped.

The oblong ring member 28 may be sized to allow multiple fingers of the user to be inserted therein. In accordance with one embodiment, the oblong ring member 28 may be sized to hold three fingers of the user therein (i.e., middle finger, ring finger and pinky finger).

A ring member 30 may be coupled to a top outer edge of the oblong ring member 28, The ring member 30 may form an index finger ring for a user to insert his/her index finger when using the device 10.

The pivot joint 16 may be used to pivotally secure the first lever member 12 to the second lever member 14. The pivot joint 16 may be positioned through the second leg member 18B of the handle section 18 and the second leg member 26B of the handle section 26.

The device 10 may have a locking clasp 32. The locking clasp 32 may be used to secure the handle section 18 and the handle section 26 together. In accordance with one embodiment, the locking clasp 32 may be formed of a hook member 34 coupled to the handle section 18. In accordance with one embodiment, the hook member 34 may be formed on a distal end of the third leg member 18C of the handle section 18. When the device 10 is in a closed position and the handle section 18 and the handle section 26 are within a predefined range of one another, the hook member 34 may engage a latch 36 formed on the handle section 26. In the present embodiment, the latch 36 may be formed on a bottom area of the oblong ring member 28.

The device 10 may have a spring 38. The spring 38 may be used to apply pressure when the handle section 18 and the handle section 26 are secured together. In accordance with one embodiment, the spring 38 may be coupled to the handle section 26. In the present embodiment shown, the spring 38 is attached to the oblong ring member 28 of the handle section 26. The spring 38 may force the handle section 18 and the handle section 26 apart thereby separating the holding section 12A from the holding section 14A when unlocking the locking clasp 32.

In operation, the user may insert his/her middle finger, ring finger and pinky finger into the oblong ring member 28, his/her index finger into the ring member 30 and his/her thumb in the ring member 22. By using all fingers and the thumb of the user, the user may be able to exert more force on the device 10.

The user may move the device 10 such that the magnet 24 may be used to pick-up a nail. By moving the user's fingers, the device 10 may open so such that the holding section 12A rotatably separates from the holding section 14A via the pivot joint 16. By looking at the indicia 20, the user may position the nail in a desired size semi-conical openings 12D. Pressing the user's hand together may cause the holding section 12A to rotatably come together with the holding section 14A via the pivot joint 16. The user may then use the locking clasp 32 to secure the handle section 18 and the handle section 26 together thereby securing the nail ire between the holding section 12A and the holding section 14A. The user may then use a hammer to hammer the nail vertically into a desired surface/object.

The foregoing description is illustrative of particular embodiments of the invention but is not meant to be a limitation upon the practice thereof. The following claims, including all equivalents thereof, are intended to define the scope of the invention.

What is claimed is:

1. A nail holding device, comprising:
a first lever, wherein the first lever comprises:
a first lever holding section;
a first lever handle section extending from the first lever holding section, wherein the first lever holding section extends horizontally below the first lever handle section; and
a plurality of semi-conical openings formed along a length of an inside edge of the first lever holding section, wherein each of the semi-conical openings has a different size opening formed in an apex area of each semi-conical opening, wherein the size openings decrease from a proximate end to a distal end of the first lever holding section;
a second lever pivotably coupled to the first lever, wherein the second lever comprises:
a second lever holding section having a smooth inside edge;
a second lever handle section extending from the second lever holding section, wherein the second lever holding section extends horizontally below the first lever handle section; and
a pivot joint pivotably coupling the first lever to the second lever.

2. The device of claim 1, comprising a magnet coupled to the first lever holding section.

3. The device of claim 1, comprising a locking mechanism to lock the first lever handle section to the second lever handle section.

4. The device of claim 1, comprising a spring forcing the first lever handle section apart from the second lever handle section.

5. The device of claim 1, wherein the first lever handle section comprises:
a first leg member of the first lever handle section extending up and away from a proximate end of the first lever holding section;
a second leg member of the first lever handle section extending horizontally from a distal end of the first leg member of the first lever handle section and being parallel to the first lever holding section;
a third leg member of the first lever handle section extending away from the second leg member of the first lever handle section, the third leg member of the first lever handle section being planer with the second leg member of the first lever handle section but angled away from the second leg member of the first lever handle section; and
a thumb ring coupled to the third leg member of the first lever handle section.

6. The device of claim 1, wherein the second lever handle section comprises:
a first leg member of the second lever handle section extending up and away from a proximate end of the second lever holding section;
a second leg member of the second lever handle section extending from the first leg member of the second lever handle and running parallel to the second lever holding section;
a third leg member of the second lever handle section extending horizontally and away from the second leg member of the second lever handle section; and
an oblong ring of the second handle section coupled to the third leg member of the second lever handle section, wherein the oblong ring is sized to hold multiple fingers of a user.

7. The device of claim 6, wherein the second leg member of the second lever handle section is “L” shaped with the bottom leg of the “L” being at approximately 135° running clockwise.

8. The device of claim 6, comprising a second lever handle section ring coupled to the oblong ring.

9. The device of claim 6, wherein the oblong ring of the second handle section is curved wherein opposing ends of the oblong ring of the second handle section are bent inwards.

10. The device of claim 1, comprising indicia formed proximate each of semi-conical openings.

11. A nail holding device, comprising:
a first lever, wherein the first lever comprises:
a first lever holding section;
a first lever handle section extending from the first lever holding section, wherein the first lever holding section extends horizontally below the first lever handle section; and
a plurality of semi-conical openings formed along a length of an inside edge of the first lever holding section, wherein each of the semi-conical openings has a different size opening formed in an apex area of each semi-conical opening, wherein the size openings decrease from a proximate end to a distal end of the first lever holding section;
a second lever pivotably coupled to the first lever, wherein the second lever comprises:
a second lever holding section having a smooth inside edge;
a second lever handle section extending from the second lever holding section, wherein the second lever holding section extends horizontally below the first lever handle section;
a pivot joint pivotably coupling the first lever to the second lever;
a locking mechanism to lock the first lever handle section to the second lever handle section; and
a spring forcing the first lever handle section apart from the second lever handle section.

12. The device of claim 11, comprising a magnet coupled to the first lever holding section.

13. The device of claim 11, wherein the first lever handle section comprises:
a first leg member of the first lever handle section extending up and away from a proximate end of the first lever holding section;
a second leg member of the first lever handle section extending horizontally from a distal end of the first leg member of the first lever handle section and being parallel to the first lever holding section;
a third leg member of the first lever handle section extending away from the second leg member of the first lever handle section, the third leg member of the first lever handle section being planer with the second leg member of the first lever handle section but angled away from the second leg member of the first lever handle section; and
a thumb ring coupled to the third leg member of the first lever handle section.

14. The device of claim 11, wherein the second lever handle section comprises:
a first leg member of the second lever handle section extending up and away from a proximate end of the second lever holding section;
a second leg member of the second lever handle section extending from the first leg member of the second lever handle and running parallel to the second lever holding section;
a third leg member of the second lever handle section extending horizontally and away from the second leg member of the second lever handle section; and
an oblong ring of the second handle section coupled to the third leg member of the second lever handle section, wherein the oblong ring is sized to hold multiple fingers of a user.

15. The device of claim 14, wherein the second leg member of the second lever handle section is “L” shaped with the bottom leg of the “L” being at approximately 135° running clockwise.

16. The device of claim 14, comprising a second lever handle section ring coupled to the oblong ring.

17. The device of claim 14, wherein the oblong ting of the second handle section is curved wherein opposing ends of the oblong ring of the second handle section are bent inwards.

18. The device of claim 11, comprising indicia formed proximate each of semi-conical openings.
